(19) United States
(12) Patent Application Publication
(10) Pub. No.: US 2010/0055387 A1
(43) Pub. Date: Mar. 4, 2010

(54) Strength to Weight Folded Honeycomb Product

(75) Inventor: Judson A. Bradford, Holland, MI (US)

Correspondence Address: WOOD, HERRON & EVANS, LLP, 2700 CAREW TOWER, 441 VINE STREET, CINCINNATI, OH, 45202, US

(73) Assignee: Bradford Company, Holland, MI (US)

(21) Appl. No.: 12/616,559

(22) Filed: Nov. 11, 2009

Related U.S. Application Data
(62) Division of application No. 11/535,623, filed on Sep. 27, 2006.

(51) Int. Cl. B32B 3/12

(52) U.S. Cl. 428/118; 428/116

(57) ABSTRACT

A honeycomb product made from a web of material which may be used alone or in a multi-layered material is provided with multiple openings to improve the strength-to-weight ratio of the honeycomb product. When folded into the appropriate shape, the openings through the web of material used to make the honeycomb product may be located on the top or bottom or sides of the cells of the honeycomb product.

### CROSS REFERENCE TO RELATED APPLICATIONS

This application is a divisional application of U.S. patent application Ser. No. 11/535,623, filed Sep. 27, 2006, entitled METHOD OF MAKING CORE MATERIAL FOR SHEET GOODS, which is fully incorporated by reference herein.

### FIELD OF THE INVENTION

This invention relates generally to a core product for structural, packaging and other applications and the process of making the core product.

### BACKGROUND OF THE INVENTION

In the aerospace industry, honeycomb cores, products or structures have preferably been used for many decades as core material for sandwich panels and boards that are resistant to buckling and bending. These honeycomb cores, which in cross-section have a generally hexagonal shape, are fabricated from aluminum or fiber paper or plastic. A sandwich structure may be prepared having two cover layers or skins adhesively bonded or otherwise secured to the honeycomb core to create a multi-laminate material which may have a high stiffness to weight ratio and a relatively high strength-to-weight ratio. Interest expressed by other industries in lightweight sandwich structures is continually growing, due at least in part to the realization of its high strength properties while maintaining low structural weight per volume of product.

The use of multi-laminate material having a honeycomb core may be used in the packaging industry. However, in automobile part packaging and comparable markets, such a product must compete with corrugated paper board or corrugated plastic or other like materials which may be produced quickly and relatively inexpensively.

U.S. Pat. No. 6,183,836 discloses a honeycomb core for use in a sandwich material in which the material of the honeycomb core is cut and then folded to create a plurality of hexagonal cells from a single planar layer or web. Due to the cuts in the web prior to folding the web, the resultant cells may be weaker than desired.

A process for producing a folded honeycomb core for use in sandwich materials from a continuous uncut web is disclosed in U.S. Pat. No. 6,726,974. U.S. Pat. No. 6,800,351 discloses another process for producing a folded honeycomb core which includes scoring a corrugated material before rotating interconnected corrugated strips. The honeycomb core resulting from using either of these methods may have material which adds to the weight of the honeycomb core but may not significantly improve the strength of the honeycomb core.

Accordingly, there is a need for a core product which may be used alone or in a multi-layered material which has approximately the same high strength-to-weight ratio as honeycomb core products, but may be produced less costly and more efficiently.

There is further a need for a process for manufacturing a core product for use alone or in a multi-layered or sandwich material which is less expensive and may be produced faster than heretofore known processes.

### SUMMARY OF THE INVENTION

These and other objectives of the invention have been attained by a honeycomb product which may be used, for example, in a multi-layered or sandwich material which has a relatively high strength-to-weight ratio due to the removal of material at preselected locations during the process of creating the honeycomb product. The honeycomb product of the present invention may be used in any desired environment or industry alone or combined with other materials.

The honeycomb product comprises a plurality of similar cells arranged in rows, adjacent cells of adjacent rows contacting each other. Each of the rows of cells is made of two row walls, each of the row walls having alternating planar and non-planar regions, the planar regions of adjacent row walls contacting each other and the non-planar regions of adjacent row walls being spaced apart and defining side walls of the cells. The non-planar regions of the row walls may be any desired shape, such as, for example, curved, polygonally or sinusoidally-shaped. For purposes of this document, these non-planar regions of the row walls may be considered half-rings and the sidewalls of the cells called rings, regardless of their cross-sectional configuration, i.e., whether they are circular, oval, or polygonal, such as hexagonal, in cross-section.

According to one aspect of the present invention, the planar regions of adjacent row walls may be bonded or joined to each other. The process of producing such a honeycomb product may incorporate the application of heat or adhesive at some stage in the process.

Each of the cells has an interior defined by a cell top, a bottom and at least two opposed side walls or half-rings which are the non-planar regions of the row walls before adjacent row walls are brought together. The side walls, tops and bottoms of the cells may be any desired shape, such as, for example, in the shape of a polygon. In one illustrated embodiment, the polygon is a hexagon so each of the cells has six side walls, a top in the form of a hexagon and a bottom in the form of a hexagon.

In order to maximize the strength-to-weight ratio of the honeycomb product, at least some of the cells have at least one opening created by at least one tool. As used herein, a tool is intended to encompass any device, or energy flowing from that device, which is used to alter the physical appearance of the material used to make the honeycomb product. Each opening or portion thereof may be a predetermined or predefined size and/or shape. These openings may be through the tops, bottoms or side walls of the cells or any portion thereof. The openings may be circular, oval or any other predetermined or predefined shape and may be any predetermined or predefined size.

The honeycomb product may be manufactured via numerous processes. Each process comprises providing a generally planar portion of a flexible web of thin plastic material, fiber composite material, plastically deformable paper or metal. The plastic material may be either a thermoplastic or thermoset material. The web may be gathered into a roll prior to being unrolled or may be otherwise stored prior to being processed as described below.

In one process, a generally planar portion of a web is punched or otherwise treated to remove material in preselected or predetermined locations on the web using at least one tool. This creates openings extending through the web which may be circular, oval or any desired size in predefined, preselected or predetermined locations on the web.

During this process, the next step comprises plastically deforming a portion of the web so at least a portion of the web has a plurality of corrugations extending in a first direction, usually parallel the direction of travel of the web or longitudinally and a plurality of flats or flattened areas or regions extending in a second direction perpendicular to the first direction. This second direction is commonly transverse or from side-to-side of the web. The corrugations may be any desired size or shape and may or may not have their own flattened surfaces.

Some of these flattened areas or flats may be raised relative to the plane of the web of material while others may remain in the plane of the web of material. This plastic deformation may be performed in numerous ways such as, for example, vacuum forming the corrugations or using cold or heated bars to create at least some of the flats or flattened areas. In some applications, a portion of the web with the openings may be heated prior to initiating the plastic deformation step or steps. If the material is a plastic material, the plastic deformation may occur in a process known as thermoforming a portion of the web.

This plastic deformation to create areas or regions having a corrugated shape and other areas or regions having a flattened shape may happen in one or more stages or steps. In order to create at least some of the flattened areas, a bar or element having a rectangular shape which may be heated may be used to plastically deform portions of the web.

After portions of the web have been plastically deformed into a desired shape, the plastically deformed portion of the web is folded along fold lines to bring opposed halves of a row of cells together to complete the row. The fold lines typically are transversely extending (from side-to-side of the web) at the edges of the flattened regions or areas of the web.

Lastly, the web is cut at any desired location and the ends of the honeycomb product secured in any desired or known manner to create a honeycomb product of a desired size. If used in a multi-layered product, one or more skins may be applied, secured or otherwise attached to the honeycomb product to create a multi-layered or multi-laminate material.

In another process, a portion of the web is punched or otherwise treated to remove material in preselected or predetermined locations on the web after the web has been at least partially plastically deformed. Again, the removal of material creates openings which may be circular, oval or any desired size in preselected or predetermined locations on the web.

Prior to the removal of material, at least a portion of the web is plastically deformed as described above to create a plurality of corrugations and a plurality of flats. In some applications, at least a portion of the web, without any openings, may be heated prior to or during the plastic deformation step or steps.

Lastly, the web is folded to create the rows of honeycomb cells and then cut and secured to create a honeycomb product of a desired size.

In another process, the creation of the openings in the web may be simultaneous with one or more plastic deformation steps. The other steps of creating the honeycomb product may be as described above.

Regardless of the process used to create the honeycomb product, one advantage of this invention is that a lightweight, strong honeycomb product may be quickly and easily manufactured in any desired size or height. The honeycomb product of this invention has a relatively high strength-to-weight ratio and may be made from many different materials quickly and less costly than heretofore. The product may be used alone, incorporated into a multi-layered material or used in any other desired manner.

### BRIEF DESCRIPTION OF THE DRAWINGS

The objectives and features of the present invention will become more readily apparent when the following detailed description of the drawings is taken in conjunction with the accompanying drawings in which:

FIG. 1 is a perspective view of a roll of web material being unrolled and openings created in the web;

FIG. 2 is a perspective view of an unrolled portion of the web of FIG. 1 having been plastically deformed;

FIG. 3 is a perspective view of a portion of the plastically deformed web of FIG. 2 being folded to create rows of cells;

FIG. 4 is a perspective view of a portion of the plastically deformed web of FIG. 3 being further folded to create rows of cells of a honeycomb product;

FIG. 5 is a perspective view of a row of cells;

FIG. 6 is a perspective view of a roll of web material being unrolled according to another aspect of this invention;

FIG. 7 is a perspective view of an unrolled portion of the web of FIG. 6 having been plastically deformed;

FIG. 8 is a perspective view of a portion of the plastically deformed web of FIG. 7 being treated to create a plurality of openings in the plastically deformed web;

FIG. 9 is a perspective view of a portion of the plastically deformed web of FIG. 8 being further folded to create rows of cells;

FIG. 10 is a perspective view of a roll of web material being unrolled then having been plastically deformed and punched simultaneously according to another aspect of this invention; and

FIG. 11 is a perspective view of a portion of the plastically deformed web of FIG. 10 being folded to create rows of cells.

### DETAILED DESCRIPTION OF THE DRAWINGS

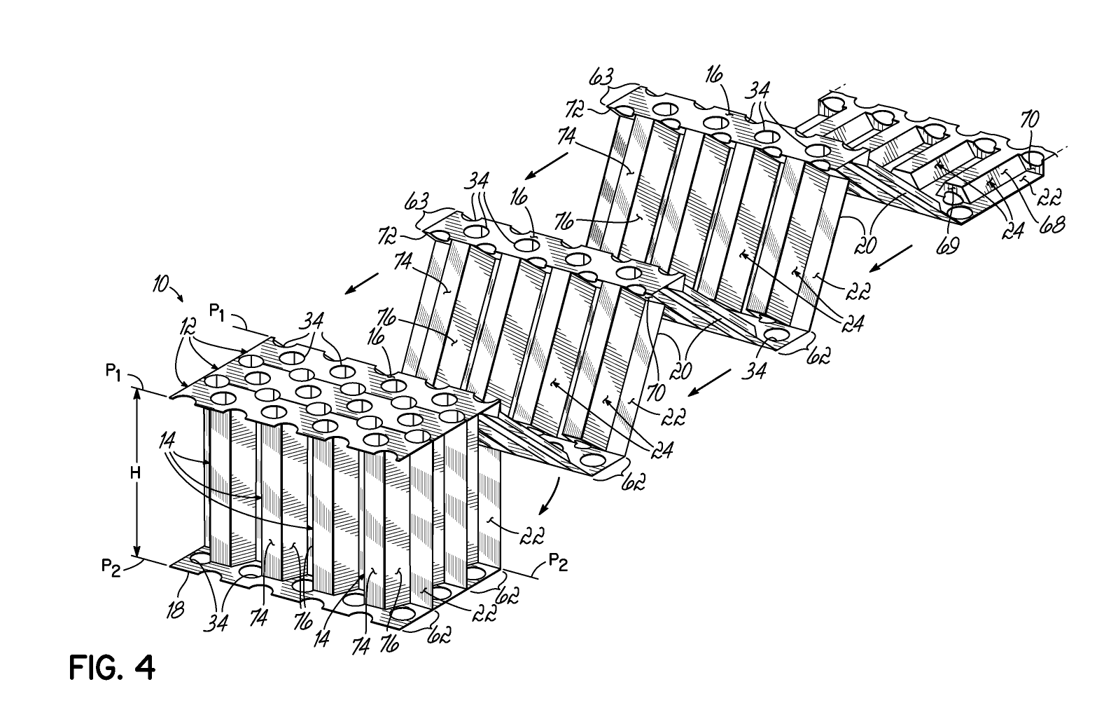

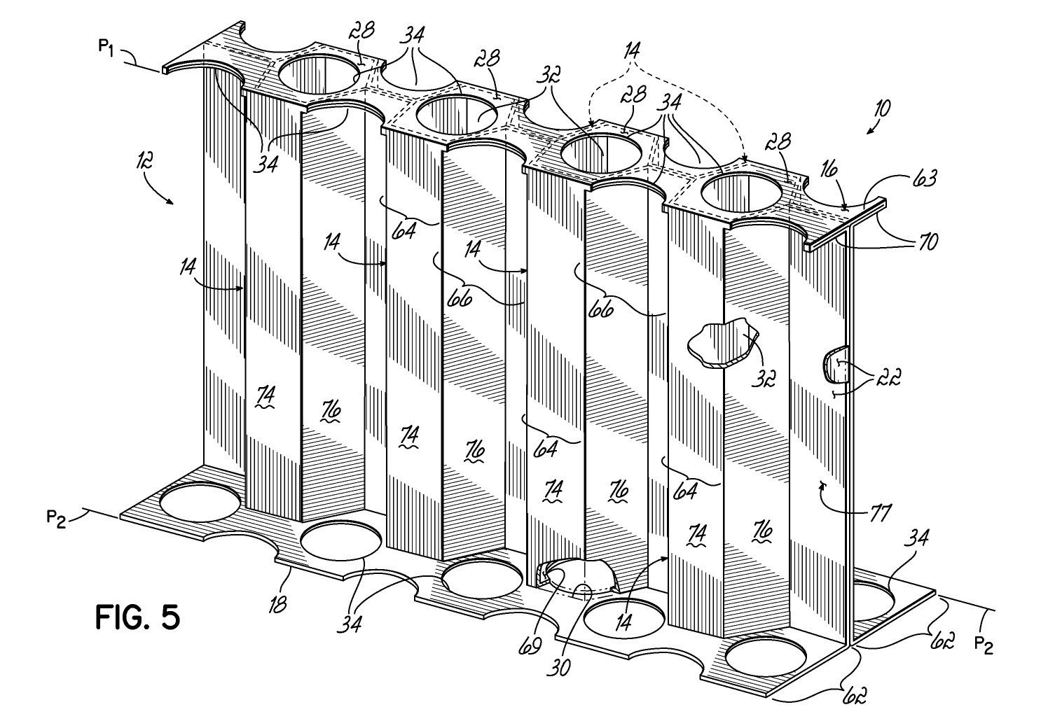

Referring to FIG. 4, a portion of a honeycomb product 10 according to one embodiment of this invention is shown. The honeycomb product 10 may be made using numerous processes including those described herein and others within the scope of the claims. FIG. 4 shows a portion of a honeycomb product 10 comprising a plurality of rows 12 of identical cells 14 made from one flexible web or sheet of material. FIG. 5 illustrates one such row 12 of cells 14. Referring to FIG. 4, the honeycomb product 10 has a generally planar upper surface 16 in a generally horizontal plane P1 and a generally planar lower surface 18 in a generally horizontal plane P2, the distance between which defines the height H of the honeycomb product 10. The height H of the honeycomb product 10 may be any desired distance and is not intended to be limited to the height of the illustrated portion of the honeycomb product.

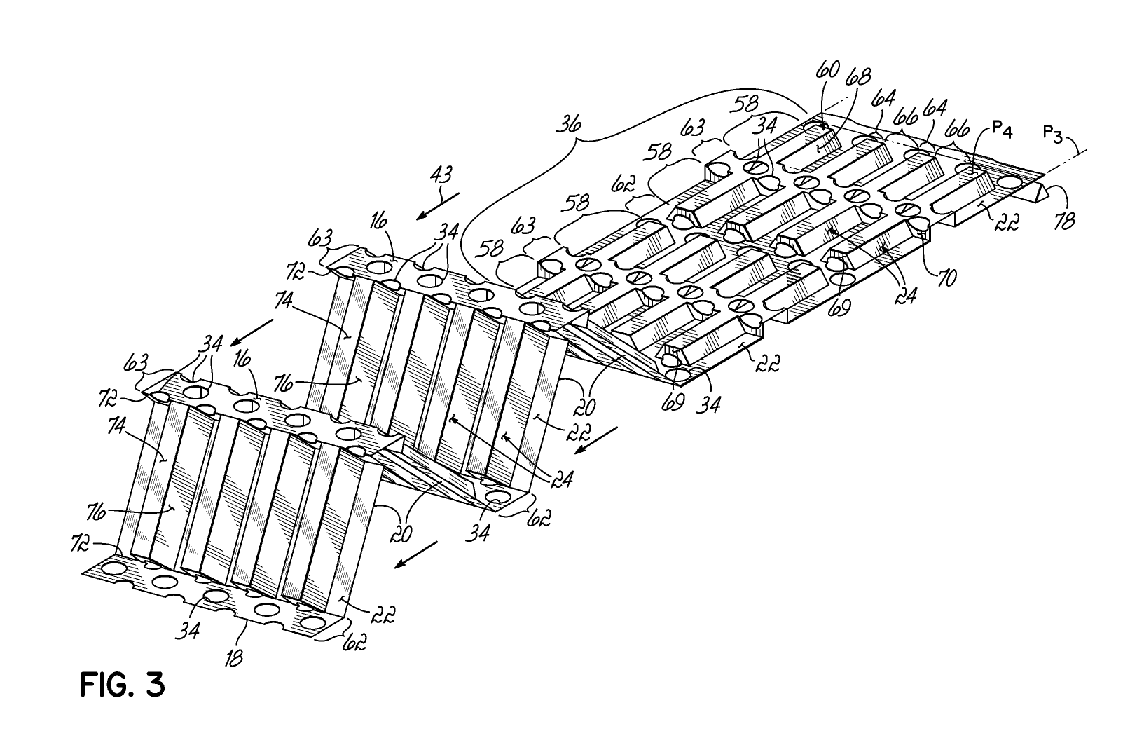

As shown in FIGS. 3 and 4, each row 12 of cells 14 is made by bringing two adjacent hinged row walls 20 together in an accordion-like manner. Each row wall 20 has alternating planar and non-planar regions or areas 22, 24, respectively. During the process of making the honeycomb product 10, adjacent row walls 20 are brought together so that the planar regions 22 of adjacent row walls 20 at least partially contact each other and the non-planar regions 24 of row walls 20 define sides or side walls 74, 76 of cells 14.

In certain applications, such as, for example, when a web of plastic material is heated at some stage in the manufacture of the honeycomb product 10, the planar regions 22 of adjacent row walls 20 may be bonded, welded or secured to each other without any additional material. Alternatively, adhesive may be used to secure adjacent row walls 20 together to complete the rows 12 of cells 14. The non-planar regions 24 of adjacent row walls 20 are spaced apart and define the shape or configuration of the cells 14 after the manufacturing process has been completed. Outermost portions or sides 74 of adjacent cells 14 in different rows 12 may contact each other and may be secured to each other in certain applications of this invention.

Although the drawings illustrate each non-planar region 24 of each row wall 20 having a cross-sectional configuration of a half-hexagon, the non-planar regions of the row walls may have any desired cross-sectional configuration, such as, for example, a curved or arcuate or sinuous cross-sectional configuration. The creation of the side walls or sides 74, 76 of the cells 14 is described in more detail below. Depending upon the application, the cells 14 may be any desired shape or size.

As best illustrated in FIG. 5, each cell 14 has a top 28 and a bottom 30 of a predetermined size and/or shape. As shown in FIG. 5, the tops 28 of the cells 14 are located in plane P1 and make up the upper surface 16 of the honeycomb product 10. Likewise, the bottoms 30 of the cells 14 are located in plane P2 and make up part of the lower surface 18 of the honeycomb product 10. The top 28, bottom 30 and sides 28 of the cell 14 define a cell interior 32.

In the illustrated embodiment, each cell top 28 and bottom 30 is a polygon and, more particularly, a hexagon. However, if the non-planar regions of the row walls were in the shape of half a cylinder, then the tops and bottoms of the cells would be circular or oval and the cells would have a cylindrical interior.

In order to reduce the weight of the honeycomb product 10 while maintaining the strength of the honeycomb product 10, a plurality of openings 34 are created in the web of material used to make the honeycomb product 10. Consequently, at least some of the cells 14 have at least one opening 34 of a predefined or predetermined size or shape. FIG. 5 shows every other one of the openings 34 being in the tops and bottoms 28, 30 of the cells 14.

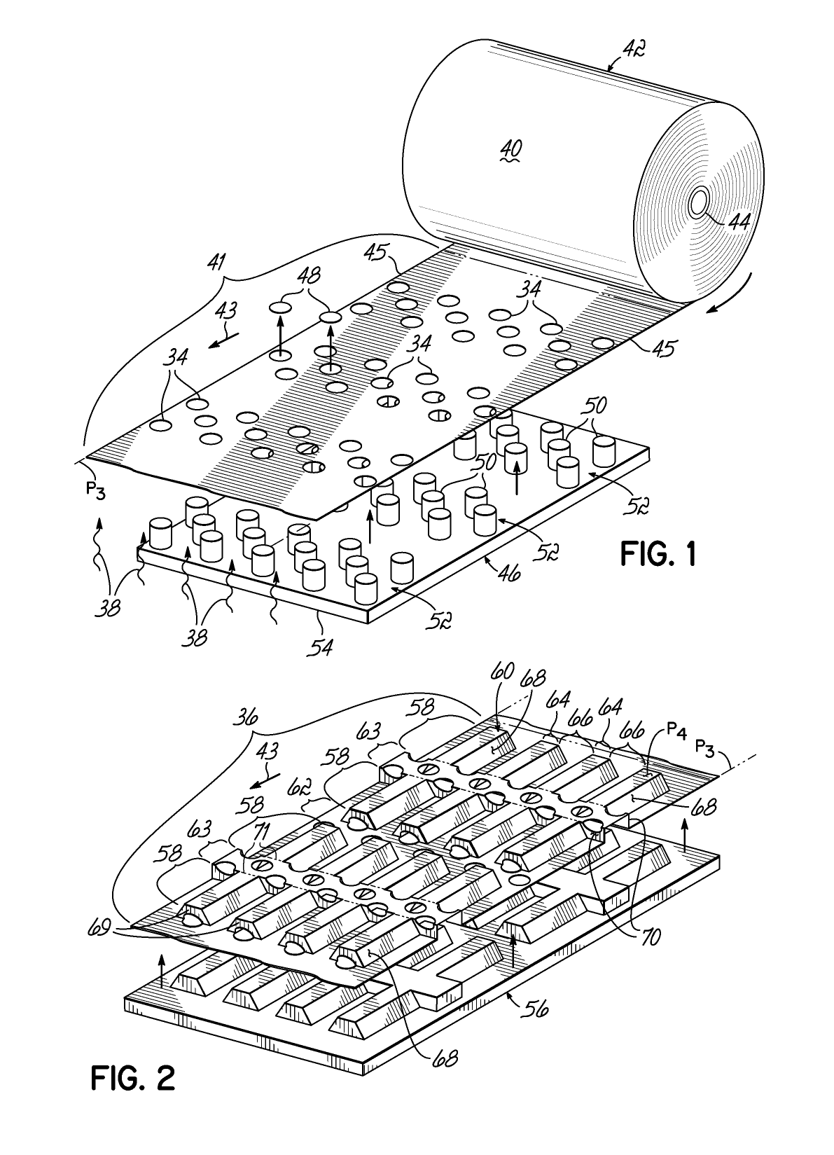

FIGS. 1-4 illustrate a method or process of making honeycomb product 10 which may be used alone or in a multi-layered material or product, or in any desired manner. FIG. 1 illustrates a flexible web of material 40 wound into a roll 42 about a core 44. The web 40 is illustrated as being unrolled in a clockwise direction. However, it may be unrolled in the opposite direction and supported or mounted in any desired manner known in the art. The unrolled portion 41 of the web 40 travels in a direction indicated by arrow 43 and has a pair of opposed side edges 45, the linear distance between which defines the width or transverse dimension of the web 40. The web 40 may be any desired material of any desired thickness and/or width. Although the web 40 is illustrated as being a solid material, it may have holes or voids therein, such as, for example, a metallic screen, a microporous plastic material or other similar material. As shown in FIG. 2, the unrolled portion 41 of the web 40 may be generally planar and located generally in a plane P3.

FIG. 1 illustrates a movable tool 46 in the form of a punch press which is used to remove material 48 from an unrolled portion 41 of the web 40 in predetermined or preselected locations. In FIG. 1, the punch press or tool 46 has a plurality of spaced punchers 50 aligned in rows 52 and mounted on a plate 54 to create a plurality of circular openings 34 through an unrolled portion of the web 40. These openings 34 become the openings in the honeycomb product 10 described above. The openings 34 may be any desired shape or size and strategically located or created at any predetermined or desired location on the web.

Although a punch press is illustrated, any other tool, such as a laser cutter, may be used to create the openings 34 through the unrolled portion 41 of the web 40 to lighten the unrolled portion 41 of the web of material 40 so that when this portion of the web 40 is formed into a honeycomb product 10, the resultant honeycomb product 10 has a relatively high strength-to-weight ratio due, at least in part, to the removal of such material during the process of manufacturing the honeycomb product. Although the tool 46 is illustrated beneath the unrolled portion 41 of web 40, tool 46 may be located above the unrolled portion 41 of web 40 or at any desired location. More than one tool 46 may be used if desired, and combinations of tools may also be used. The term tool is not intended to be limiting and may include any tool known in the art including, for example, lasers.

After the openings 34 have been created through an unrolled portion 41 of the web 40, the unrolled portion 41 of the web 40 may be heated by any desired method. Such heating is illustrated schematically by arrows 38. This method step is optional and may be used in certain applications only. In other applications it may be omitted partially or entirely. Although it is shown schematically after the openings 34 have been created and prior to plastically deforming the unrolled portion 41 of the web 40, this heating step may occur any time during the manufacturing process including prior to creating the openings 34.

FIG. 2 illustrates another step in this process of making honeycomb product 10 comprising plastically deforming at least portions of the unrolled portion 41 of the web 40 to create a plastically deformed web 36. This plastic deformation may include using a movable tool 56, such as shown in FIG. 2, to create a plurality of corrugated regions or areas 58 comprising a plurality of corrugations 60 extending in a first direction generally parallel the direction of travel 43 of the web 40 or longitudinally, and a plurality of flattened areas or regions 62, 63 each extending in a second direction perpendicular to the first direction, transversely or from side-to-side. The size of these regions or areas 58, 62 and 63 may vary depending upon the desired size or shape of the cells 14 of the honeycomb product 10.

Although the tool 56 is illustrated beneath the unrolled portion 41 of web 40, tool 56 may be located above the unrolled portion 41 of web 40 or at any desired location. More than one tool 56 may be used if desired, and combinations of tools may also be used. Again, the term tool is not intended to be limiting and may include any tool known in the art.

As seen in FIG. 2, the corrugations 60 may comprise co-planar flattened peaks 64 located generally in a horizontal plane P4 above the plane P3 of the unrolled portion 41 of the web 40 and flattened valleys 66 in the plane P3 of the unrolled portion 41 of the web 40 with generally rectangular flat connecting portions 68 extending therebetween. The planes P3 and P4 are illustrated as being parallel, the distance therebetween defining the height of the corrugations 60. Lastly, each corrugation 60 may have an end portion 69 which extends between a peak 64 and a valley 66. These end portions 69 are illustrated as each being in the shape of a trapezoid, but may be other shapes, depending upon the shape of the corrugations.

As best illustrated in FIG. 2, each generally rectangular, transversely extending flat or flattened area 62 is located in the plane P3 of the unrolled portion 41 of the web 40. Each generally rectangular, transversely extending flat or flattened area 63 is located in plane P4 above the plane P3 of the unrolled portion 41 of the web 40 and co-planar with the plane of the flattened peaks 64 of corrugations 60. Flattened areas 62 and 63 alternate between corrugated areas 58. Due to the shape of the tool 56, each flat or flattened area 63 has side walls 70 extending from the outer edges of the flat 63 to the flattened valleys 66 in the corrugated regions 58. These side walls 70 are illustrated as each being in the shape of a trapezoid, but may be other shapes, depending upon the shape of the corrugations. Although not shown, the corrugations may have a semi-circular, sinuous, curved or other cross sectional configuration.

As shown in FIG. 3, the plastically deformed web portion 36 is then folded along transversely extending fold lines 72 located generally on the edges of the flats 62, 63. Such fold lines 72 may be optionally scored or perforated at any step in the manufacturing process with cuts 71 to assist folding. See FIG. 2. Such scoring may be made by a separate tool or tools. As shown in FIGS. 3 and 5, after the plastically deformed web portion 36 is folded along transversely extending fold lines 72, side walls 70 lay underneath and may contact the raised flat 63, and end walls 69 of corrugations 60 rest on and contact flats 62.

As shown in FIGS. 2-5, the strategic locations of the openings 34 may be such that some of the openings 34 are located along the flats 62, 63 of the plastically deformed web portion 36, and others are located along fold lines 72 such that material is removed or missing from parts of end portions 69 of the corrugations 60 and parts of side walls 70 of the flats 62, 63 in addition to portions of flats 62, 63. Each opening 34 is illustrated as being generally circular, but may be any preselected shape or size. As shown in FIGS. 4 and 5, when adjacent row walls 20 are compressed or otherwise brought together, every cell 14 has a hole 34 through the top 28 of the cell 14 and another hole 34 through the bottom 30 of the cell 14.

As best illustrated in FIGS. 4 and 5, side walls 70 abut and are underneath portions of the raised flats 63. These two ply areas comprise approximately half of the tops 28 of some of the cells 14. In such cells, the bottom 30 of the cell 14 is a single ply having a hole 34 which was formed in the flat 62 before folding. As shown in FIG. 5, end walls 69 abut and are above portions of the flats 62 to form approximately half of the bottoms 30 of other cells 14. In such cells, the top 28 of the cell 14 is a single ply having a hole 34 which was formed in the flat 63 prior to folding. Thus, in one row 12 of cells 14, each cell 14 has a single ply top 28 and a double-ply bottom 30. In adjacent rows of cells 14 to row 12, each cell 14 has a double-ply top 28 and a single-ply bottom 30.

As shown in FIGS. 4 and 5, after the plastically deformed web portion 36 is folded along transversely extending fold lines 72, the corrugations 60 or non-planar regions 24 of the row walls 20 become the side walls 74, 76 of the cells 14. More particularly, the generally planar peaks 64 of corrugations 60 become the outmost side walls 74 of the cells 14, and the generally planar connecting portions 68 of corrugations 60 become additional side walls 76 of the cells 14. See FIG. 5. As shown in FIG. 5, within a row 12 of cells 14, the planar portions 22 of row walls 20 come together to create flattened two-ply portions 77 of row 12. Side walls 74, 76, along with the top 28 and bottom 30 of each cell 14, define a cell interior 32 which may be accessed by openings or holes 34. See FIG. 5.

The last step in the process is to cut the unrolled portion 41 of web 40 at any desired location. FIG. 3 illustrates a cutter 78 at one location. However, one or more cutting tools or devices may be used at any desired location to create a honeycomb product 10 of a desired length.

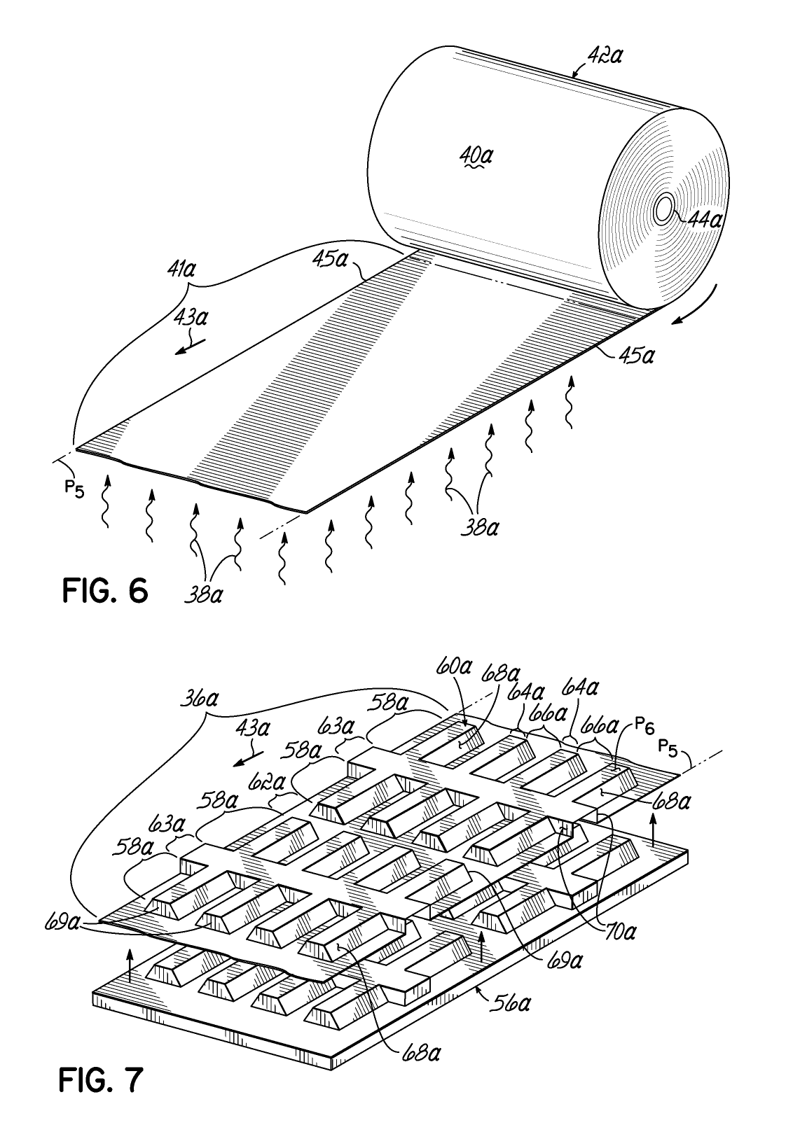

FIGS. 6-9 illustrate another method or process of making a honeycomb product which may be used alone or in a multi-layered material or product. FIG. 6 illustrates a flexible web of material 40a wound into a roll 42a about a core 44a. The web of material 40a is illustrated as being unrolled in a clockwise direction. However, it may be unrolled in the opposite direction and supported or mounted in any desired manner known in the art. The unrolled portion 41a of the web 40a travels in a direction indicated by arrow 43a and has a pair of opposed side edges 45a, the linear distance between which defined the width or transverse dimension of the web 40a. The web 40a may be any desired material of any desired thickness and/or width. The unrolled portion 41a of the web 40a may be generally planar and located generally in a plane P5.

After a portion 41a of the web 40a has been unrolled, the unrolled portion 41a of the web 40a may be heated by any desired method. Such heating is illustrated schematically by arrows 38a. This method step is optional and may be used in certain applications only. In other applications, any portion of web 40a may be omitted partially or entirely. Although it is shown schematically prior to plastically deforming an unrolled portion 41a of the web 40a, this heating step may occur any time during this manufacturing process.

FIG. 7 illustrates another step in this process of making honeycomb product 10a comprising plastically deforming at least portions of the unrolled web 41a to create a plastically deformed web portion 36a. This plaster deformation may include using a movable tool 56a, such as shown in FIG. 7 to create a plurality of corrugated regions or areas 58a comprising a plurality of corrugations 60a extending in a first direction generally parallel the direction of travel 43a of the web 40a or longitudinally, and a plurality of flattened areas or regions 62a, 63a each extending in a second direction perpendicular to the first direction, transversely or from side-to-side. The size of these regions or areas 58a, 62a and 63a may vary depending upon the desired size or shape of the cells 14a of the honeycomb product 10a.

Although the tool 56a is illustrated beneath the unrolled portion 41a of web 40a, tool 56a may be located above the unrolled portion 41a of web 40a or at any desired location. More than one tool 56a may be used if desired, and combinations of tools may also be used. Again, the term tool is not intended to be limiting and may include any tool known in the art.

As seen in FIG. 7, the corrugations 60a may comprise co-planar flattened peaks 64a in a plane P6 above the plane P5 of the unrolled portion 41a of the web 40a and flattened valleys 66a in the plane P5 of the unrolled portion 41a of the web 40a with generally rectangular flat connecting portions 68a extending therebetween. Lastly, each corrugation 60a may have an end portion 69a which extends between a peak 64a and a valley 66a. These end portions 69a are illustrated as each being in the shape of a trapezoid, but may be other shapes, depending upon the shape of the corrugations.

As best illustrated in FIG. 7, each generally rectangular, transversely extending flat or flattened area 62a is located in the plane P5 of the unrolled portion 41a of the web 40a. Therefore, each generally rectangular, transversely extending flat or flattened area 63a is located in plane P6 above the plane P5 of the unrolled portion 41a of the web 40a and co-planar with the flattened peaks 64a of corrugations 60a. Flattened areas 62a and 63a alternate between corrugated areas 58a. Due to the shape of the tool 56a, each corrugation 60a has side walls 70a extending from the outer edges of the flat 63a to the flattened valleys 66a in the corrugated regions 58a. These side walls 70a are illustrated as each being in the shape of a trapezoid, but may be other shapes, depending upon the shape of the corrugations. Although not shown, the corrugations may have a semi-circular, sinuous, curved or other cross sectional configuration.

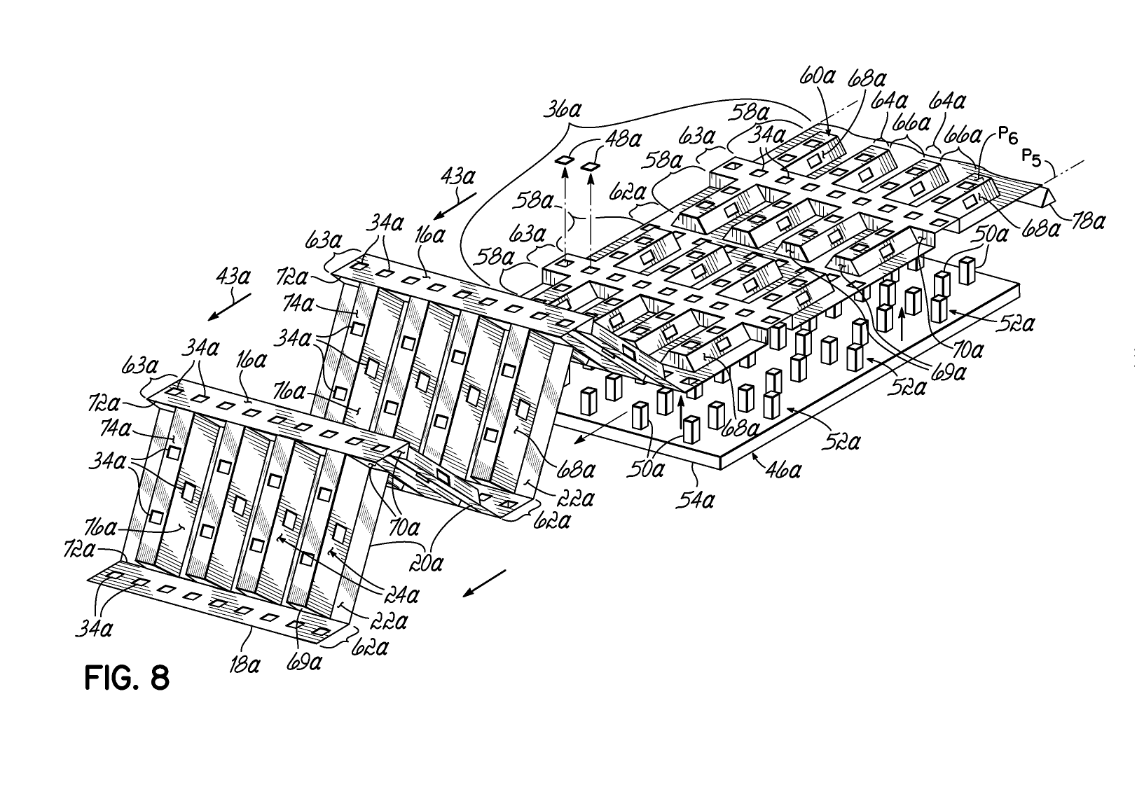

FIG. 8 illustrates a movable tool 46a in the form of a punch press, which is used to remove material 48a from plastically deformed web portion 36a in predetermined or preselected locations. In FIG. 8, the punch press or tool 46a has a plurality of punchers 50a aligned in rows 52a and mounted on a plate 54a at preselected or predetermined locations or positions to create a plurality of rectangular openings 34a through predetermined or preselected portions of the plastically deformed web 36a. These openings 34a become the openings in the honeycomb product 10a described above. Although illustrated as being rectangular, the openings 34a may be of any desired size or shape and strategically located at any desired location on a portion of unrolled web. For example, the holes or openings 34a may be created at the same locations shown in FIGS. 2-5 and be any predetermined or predefined size or shape.

Although a punch press is illustrated, any other tool, such as a laser cutter, may be used to create the openings 34a through any portion of the unrolled plastically deformed portion 36a of the web so that the resultant honeycomb product 10a has a relatively high strength-to-weight ratio due, at least in part, to the removal of such material during the process of manufacturing the honeycomb product.

Although the tool 46a is illustrated beneath the plastically deformed portion 36a of the web 40a, tool 46a may be located above the plastically deformed portion 36a of the web 40a or at any desired location. More than one tool 46a may be used if desired.

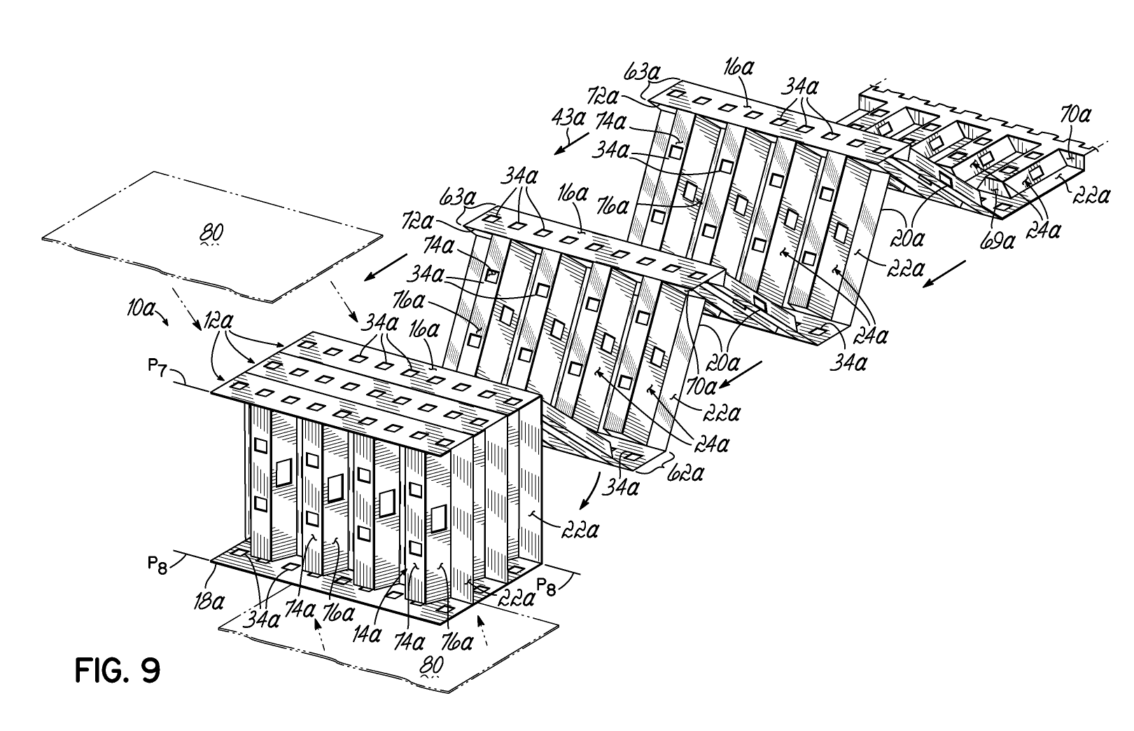

As shown in FIGS. 8-9, the strategic locations of the openings 34 are such that the openings 34a are located along the flats 62a, 63a of the plastically deformed web of material 36a, along the flattened peaks 64a of the corrugations 60a and along connecting portions 68a of corrugations 60. As shown in FIG. 8, each opening 34a is illustrated as being generally rectangular, but may be any predefined or preselected shape or size. As shown in FIGS. 8 and 9, some of the holes 34a in flats 62a, 63a extend through the bottoms 30a and tops 28a of cells 14a. Likewise, holes 34a through the flattened peaks 64a of the corrugations 60a extend through the side walls 74a of cells 14a.

As shown in FIG. 8, after the openings 34a have been bored, punched or otherwise made, the plastically deformed web portion 36a is then folded along transversely extending fold lines 72a located generally on the edges of the flats 62a, 63a. As shown in FIGS. 8 and 9, after the plastically deformed web 36a is folded along transversely extending fold lines 72a, side walls 70a lay underneath the raised flats 63a and end walls 69a of corrugations 60a rest on flats 62a.

The last step in the process is to cut the unrolled portion 41a of web 40a at any desired location. FIG. 8 illustrates a cutter 78a at one location. However, one or more cutting tools or devices may be used at any desired location to create a honeycomb product 10a of a desired length.

FIG. 9 shows a portion of the resultant honeycomb product 10a along with skins or layers 80 (shown in phantom), one or both of which may be secured to at least one of the upper and lower surfaces 16a, 18a of honeycomb product 10a to create a multi-layered product for any desired use. Such skins may be incorporated into a product having a honeycomb product made in accordance with any aspect of the present invention including via any method described or contemplated herein.

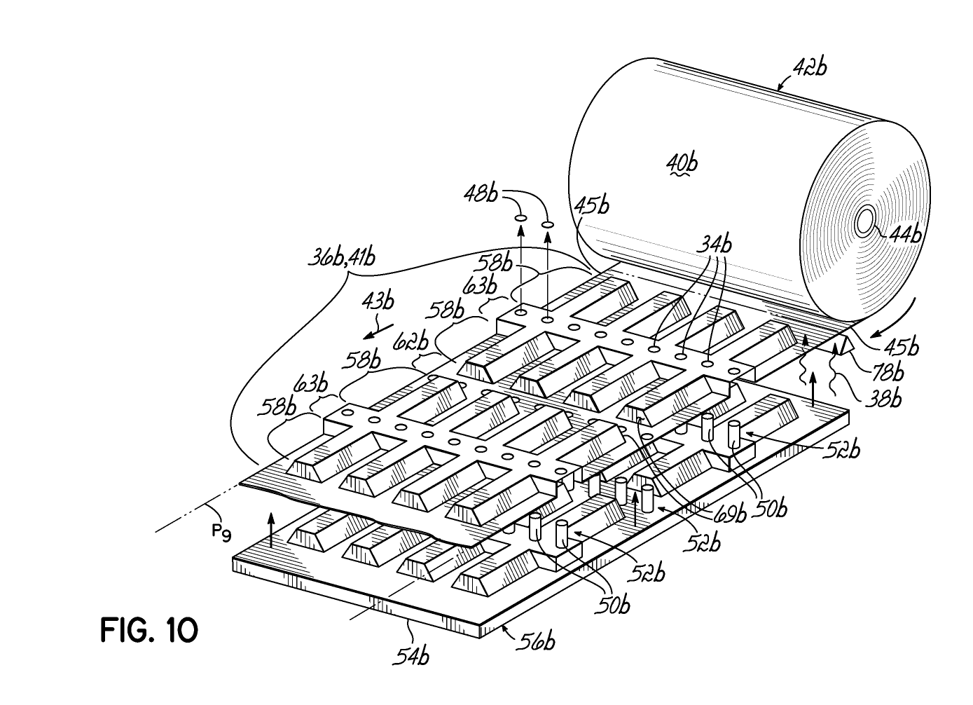

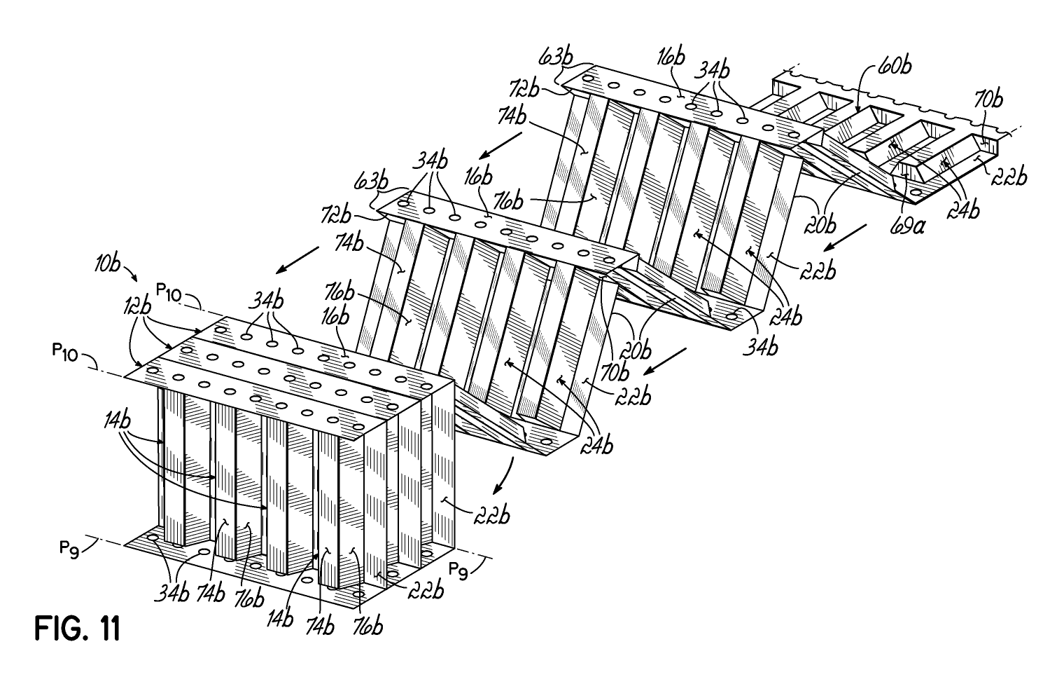

FIGS. 10-11 illustrate another method or process of making a honeycomb product 10b, which may be used alone or in a multi-layered material or product. FIG. 10 illustrates a flexible web of material 40b wound into a roll 42b about a core 44b. The web of material 40b is illustrated as being unrolled in a clockwise direction. However, it may be unrolled in the opposite direction and supported or mounted in any desired manner known in the art. The unrolled portion 41b of the web 40b travels in a direction indicated by arrow 43b and has a pair of opposed side edges 45b, the linear distance between which defined the width or transverse dimension of the web 40b. The web 40b may be any desired material of any desired thickness and/or width. The unrolled portion 41b of the web 40b may be generally planar and located generally in a plane P9.

After a portion 41b of the web 40a has been unrolled, the unrolled portion 41b of the web 40b may be heated by any desired method to facilitate processing. Such heating is illustrated schematically by arrows 38b. This method step is optional and may be used in certain applications only. In other applications, it may be omitted partially or entirely. Although it is shown schematically prior to plastically deforming an unrolled portion 41b of the web 40b, this heating step may occur any time during this manufacturing process.

FIG. 10 illustrates another step in this process of making honeycomb product 10a comprising plastically deforming at least portions of the unrolled web 41b. Plastic deformation may include using a movable tool 56b, such as shown in FIG. 10 to create a plurality of corrugated regions or areas 58b comprising a plurality of corrugations 60b extending in a first direction generally parallel the direction of travel 43b of the web 40b or longitudinally, and a plurality of flattened areas or regions 62b, 63b each extending in a second direction perpendicular to the first direction, transversely or from side-to-side. The size of these regions or areas 58b, 62b and 63b in FIG. 10 may vary depending upon the desired size or shape of the cells 14b of the honeycomb product 10b in FIG. 11.

FIG. 10 illustrates a movable tool 56b which, in addition to plastically deforming the unrolled portion 41b of web 40b, is also used to remove material 48b from plastically deformed web portion 36a in predetermined or preselected locations. In this embodiment, removal of material 48b occurs simultaneously with the operation of plastically deforming the unrolled portion 41b of web 40b. In FIG. 10, the tool 56b has a plurality of punchers 50b mounted on a plate 54b at preselected or predetermined locations or positions to create a plurality of circular openings 34b through predetermined or preselected portions of the plastically deformed web portion 36b. These openings 34b become the openings in the honeycomb product 10b described above. Although illustrated as circular, the openings 34b may be of any desired shape and strategically located at any desired location on a portion of the unrolled web of material.

Although one configuration of tool 56b is illustrated, any other tool may be used to plastically deform unrolled portions of web 40b and simultaneously create openings 34b through any portion of the unrolled portion of the web to lighten the plastically deformed web portion 36a so that when this portion of the web 36b is folded to create honeycomb product 10b, the resultant honeycomb product 10b has a relatively high strength-to-weight ratio due, at least in part, to the removal of such material during the process of manufacturing the honeycomb product 10b.

Although the tool 56b is illustrated beneath the unrolled portion 41b of web 40b, tool 56b may be located above the unrolled portion 41b of web 40b or at any desired location. More than one tool 56b may be used if desired.

As shown in FIGS. 10 and 11, after the unrolled portion of the web has been plastically deformed and the openings 34b have been created, the plastically deformed web portion 36b is then folded along transversely extending fold lines 72b located generally on the edges of the flats 62b, 63b. As shown in FIGS. 10 and 11, after the plastically deformed web of material 36b is folded along transversely extending fold lines 72b, side walls 70b lay underneath the raised flats 63b and end walls 69b of corrugations 60b rest on flats 62b.

The last step in the process is to cut the unrolled portion 41b of web 40b at any desired location. FIG. 10 illustrates a cutter 78b at one location. However, one or more cutting tools or devices may be used at any desired location to create a honeycomb product 10b of a desired length.

While I have described several preferred embodiments of the present invention, persons skilled in the art will appreciate changes and modifications which may be made without departing from the spirit of the invention. For example, although one configuration of a cell is illustrated and described, the cells of the present invention may be other configurations, such as cylindrical in shape. Therefore, I intend to be limited only by the scope of the following claims and equivalents thereof:

I claim:

1. A honeycomb product comprising:
a plurality of similar cells arranged in rows, each of the rows of cells being made of two row walls, each of said row walls having alternating planar and non-planar regions, the planar regions of adjacent row walls contacting each other and the non-planar regions of adjacent row walls defining side walls of the cells, each of the cells having a top and bottom;
wherein at least some of the cells have at least one opening created by at least one tool.

2. The honeycomb product of claim 1 wherein said tops and bottoms of said cells are each in the shape of a polygon.

3. The honeycomb product of claim 1 wherein each of the openings allows access to an interior of the cell.

4. The honeycomb product of claim 3 wherein each of the cells has two openings.

5. The honeycomb product of claim 1 wherein at least some of the openings are in side walls of at least some of the cells.

6. The honeycomb product of claim 1 wherein said honeycomb product is made of plastic material.

7. The honeycomb product of claim 1 wherein the honeycomb product is made of metal.

8. The honeycomb product of claim 1 wherein each of the openings is a predefined size.

9. The honeycomb product of claim 1 wherein each non-planar region comprises three generally planar walls.

10. The honeycomb product of claim 1 wherein said tops and bottoms of said cells are each in the shape of a hexagon.

11. The honeycomb product of claim 1 wherein each of the openings is a predefined shape.

12. The honeycomb product of claim 1 wherein the openings are circular.

13. The honeycomb product of claim 1 wherein at least some of the openings are located in the tops and bottoms of the cells.

14. A honeycomb product comprising:
a planar web of material having a plurality of openings formed therethrough at predetermined locations, said web of material being formed into a pre-folded web comprising a plurality of co-planar raised rectangular areas and a plurality of generally corrugated areas between the raised rectangular areas, said pre-folded web being folded to create a plurality of identical cells arranged in rows, each of the cells having a plurality of side cell walls, a top and a bottom.

15. The honeycomb product of claim 14 wherein the cell tops and bottoms are each in the shape of a polygon.

16. The honeycomb product of claim 14 wherein each cell has six side walls.

17. The honeycomb product of claim 15 wherein the polygon is a hexagon.

18. The honeycomb product of claim 14 wherein the openings are circular.

19. The honeycomb product of claim 14 wherein at least some of the openings are located in the tops and bottoms of the cells.

20. The honeycomb product of claim 14 wherein each row of cells comprises two row walls, each of said row walls being in the shape of a half-ring in a first region and being generally planar in a second region, the generally planar second regions of adjacent row walls being joined together.

21. A honeycomb product comprising:
a web of thermoplastic material having a plurality of openings formed therethrough, said web of thermoplastic material being heated, plastically deformed and folded to create a plurality of identical cells arranged in rows, each of the rows of cells comprising two row walls joined together, each of said row walls being in the shape of a half-ring in a first region and being generally planar in a second region, the generally planar second regions of adjacent row walls being joined together and the first regions of the row walls defining side walls of the cells, each of the cells having a top and bottom.
